(19) United States
(12) Patent Application Publication
(10) Pub. No.: US 2015/0325863 A1
(43) Pub. Date: Nov. 12, 2015

(54) MATERIAL FOR FUEL CELL SEPARATORS AND METHOD FOR PRODUCING SAME

(71) Applicant: KABUSHIKI KAISHA KOBE SEIKO SHO (KOBE STEEL, LTD.), Kobe-shi, Hyogo (JP)

(72) Inventors: Satoru TAKADA, Kobe-shi (JP); Jun SUZUKI, Kobe-shi (JP); Toshiki SATO, Kobe-shi (JP)

(73) Assignee: KABUSHIKI KAISHA KOBE SEIKO SHO (KOBE STEEL, LTD.), Kobe-shi, Hyogo (JP)

(21) Appl. No.: 14/652,196

(22) PCT Filed: Jan. 22, 2014
(86) PCT No.: PCT/JP2014/051217

§ 371 Date: Jun. 15, 2015

(30) Foreign Application Priority Data
Jan. 30, 2013 (JP) 2013-015537

(51) Int. Cl. H01M 8/02; C23C 8/20

(52) U.S. Cl. CPC H01M 8/0206; H01M 8/0213; H01M 8/0208; H01M 8/0228; C23C 8/20

(57) ABSTRACT

A material for fuel cell separators having excellent adhesion between a base and a carbon layer, excellent conduction durability and excellent production efficiency; and a method for producing the material are provided. The method includes: a coating step wherein a coating layer that contains carbon and a binder compound containing a carbon atom and an oxygen atom is formed on the surface of a titanium base of titanium or a titanium alloy with a thickness of 40-200 μm; and a heat treatment step treating the titanium base covered with the coating layer. The titanium base covered with the coating layer is wound into a coil shape and then subjected to the heat treatment carried out in a vacuum atmosphere of 10 Pa or less. A carbon layer and an intermediate layer containing titanium carbide are formed from the coating layer in the heat treatment step.

### TECHNICAL FIELD

The present invention relates to a material for fuel cell separators used for a fuel cell, a method for producing the material for fuel cell separators, and a method for producing a fuel cell separator.

### BACKGROUND ART

A fuel cell capable of continuously taking out electric power by continuously supplying fuel such as hydrogen and an oxidizing agent such as oxygen has high power generating efficiency unlike a primary battery such as a dry cell and a secondary battery such as a lead storage battery and is not affected much by the scale of the system, noise and vibration are less, and therefore the fuel cell is expected as an energy source covering various uses and scales. More specifically, a fuel cell has been developed as a polymer electrolyte fuel cell (PEFC), an alkaline electrolyte fuel cell (AFC), a phosphoric acid fuel cell (PAFC), a molten carbonate fuel cell (MCFC), a solid oxide fuel cell (SOFC), a biofuel cell and the like. Among them, development of the polymer electrolyte fuel cell has been in progress for a fuel cell automobile, a fuel cell for home use (cogeneration system for home use), a portable device such as a cellular phone and personal computer.

The polymer electrolyte fuel cell (may be hereinafter referred to also simply as “fuel cell”) makes a solid polymer electrolyte membrane sandwiched by an anode electrode and a cathode electrode a unit cell, and is constituted as a stack obtained by stacking the plurality of unit cells through electrodes called separators (referred to also as bi-polar plates) formed with grooves that constitute flow passages of gas (hydrogen, oxygen and the like). Also, the fuel cell can increase its output by increasing the number of the cells per stack.

Further, because the separator for a fuel cell is a component for taking out the electric current generated to outside the fuel cell, for its material, such characteristics are required that the contact resistance (phenomenon of drop of the voltage between the electrode and the surface of the separator because of an interfacial phenomenon) is low and the low contact resistance is maintained for a long period of time during use as a separator.

Also, because the inside of the cells of the fuel cell is of a hot and acidic atmosphere, the separator for a fuel cell should maintain high electric conductivity for a long period of time even under such atmosphere. In order to exert the performance, it is required to coat a conductive layer excellently on the substrate of the separator, to reduce the area where the substrate is exposed, and to improve adhesion between the substrate and the conductive layer formed on the substrate.

Particularly, in automobile use, because the separator surface is subjected to friction by contacting carbon cloth and carbon paper because of vibration during traveling and the like, the conductive layer of the separator should join the substrate very securely.

In order to satisfy such requirement, a separator using metal material as the substrate is directed, and such proposals as described below have been made for example.

A separator has been proposed in which a metal material such as an aluminum alloy, stainless steel, nickel alloy, and titanium alloy capable of thinning and having excellent workability and high strength is made the substrate, and corrosion resistance and electric conductivity are imparted by coating a noble metal such as Au and Pt having both of corrosion resistance and conductivity. However, because these noble metal materials are very expensive, the cost increases.

Therefore, with regard to the problem, a method for producing a metal separator not using noble metal materials has been proposed.

For example, there are proposed a method of forming a middle layer and a conductive thin film on the surface of the oxidized film of the substrate itself by a vapor phase film forming method (Patent Literature 1), and a method of forming a surface treatment layer composed of a portion formed of a semi-metal element and the like and a portion formed of carbon and the like on the surface of the substrate by a vapor phase film forming method (Patent Literature 2).

Also, a method of forming a carbon layer on the surface of the titanium substrate and thereafter forming a middle layer of titanium carbide by heat treatment has been studied (Patent Literature 3).

### CITATION LIST

### Patent Literature

[Patent Literature 1] Japanese Unexamined Patent Application Publication No. 2004-185998
[Patent Literature 2] Japanese Unexamined Patent Application Publication No. 2004-014208
[Patent Literature 3] Japanese Unexamined Patent Application Publication No. 2012-028046

### SUMMARY OF INVENTION

### Technical Problem

However, with respect to the technologies disclosed in Patent Literatures 1 and 2, because the middle layer, conductive thin film and the like are formed on the surface of the substrate by the vapor phase film forming method, it is concerned that adhesion at the interface of each layer is weak. Also, it is inferior in productivity because the vapor phase film forming method is employed.

Further, according to the technology disclosed in Patent Literature 3, although the performance can be secured sufficiently, heat treatment is executed by continuous annealing or by a batch process of cut sheets, and the technology is inferior in productivity and incurs the cost. More specifically, the continuous annealing incurs a high cost because argon gas or nitrogen gas is required to flow by large quantity in order to obtain non-oxygen atmosphere. Also, the batch process of the cut sheets has a problem in mass productivity because handling of the material in the post processes becomes complicated.

The present invention has been developed in view of the problems described above, and its object is to provide a material for fuel cell separators excellent in adhesion and conductive durability (characteristic of maintaining conductivity for a long period of time) between the substrate and the carbon layer, and excellent also in the production efficiency, and a method for producing the same.

### Solution to Problem

As a result of intensive studies, the present inventors found out that the problem described above could be solved by coating the surface of the titanium substrate (may be hereinafter described also simply as “substrate”) with a coating layer including a binder compound and carbon and thereafter executing heat treatment under vacuum atmosphere in a state the titanium substrate was wound into a coil shape in a heat treatment step that was one of the step of producing the material for fuel cell separators, and the present invention was completed.

More specifically, the method for producing a material for fuel cell separators in relation with the present invention is a method for producing a material for fuel cell separators including a coating step of forming a coating layer including a binder compound containing carbon atoms and oxygen atoms and carbon on the surface of a titanium substrate formed of titanium or titanium alloy with 40 μm or more and 200 μm or less thickness, and a heat treatment step of executing heat treatment of the titanium substrate coated by the coating layer, in which the titanium substrate coated by the coating layer is subjected to heat treatment in a state wound into a coil shape, the heat treatment step is executed under vacuum atmosphere of 10 Pa or below, and a carbon layer is formed from the coating layer and a middle layer containing titanium carbide is formed between the titanium substrate and the carbon layer in the heat treatment step.

Thus, in the method for producing a material for fuel cell separators in relation with the present invention, the carbon layer is formed and the layer containing titanium carbide or the layer containing titanium carbide and carbon dissolved titanium (hereinafter referred to as “middle layer” when it is appropriate) is formed between the titanium substrate and the carbon layer by executing heat treatment of the coating layer. As a result, the middle layer can improve adhesion between the substrate and the carbon layer.

Also, by executing the heat treatment of the titanium substrate coated by the coating layer in a state wound on a roller, working can be performed with high production efficiency. Further, when the heat treatment of the titanium substrate is executed in a state wound into a coil shape, by executing the heat treatment under vacuum atmosphere of 10 Pa or below, the event that the coating layer is oxidized by generated gas and adhesion of the carbon layer is deteriorated can be suppressed.

In the method for producing a material for fuel cell separators in relation with the present invention, it is preferable that the substrate is a cold rolled material, and is not subjected to annealing treatment after cold rolling. In this case, two heat treatment steps of heat treatment for forming the middle layer and the annealing treatment can be integrated into one heat treatment step, and the process can be simplified.

Also, it is preferable that a crimping step of crimping titanium substrate coated by the coating layer is further executed after the coating step and before the heat treatment step. By crimping the coating layer to the substrate, adhesion of the carbon layer formed in the heat treatment step can be further improved.

Further, in the method for producing a material for fuel cell separators in relation with the present invention, it is preferable that a straightening step of straightening a warp of the titanium substrate is further executed after the heat treatment step. When flatness is required in forming the material for fuel cell separators, the flatness can be improved.

Also, it is preferable that the coil inside diameter of the titanium substrate coated by the coating layer is 400 mm or more. Thus, the warp of the titanium substrate reduces, and the straightening step described above becomes unnecessary.

In the method for producing a material for fuel cell separators in relation with the present invention, it is preferable that the heat treatment step includes a decompression step of carrying the titanium substrate coated by the coating layer into a first chamber and decompressing the pressure of the first chamber, a vacuum heat treatment step of moving the titanium substrate from the first chamber decompressed to a second chamber maintained at vacuum atmosphere, and heating the titanium substrate and subjecting the titanium substrate to heat treatment in the second chamber, and a cooling step of moving the titanium substrate subjected to the heat treatment to a third chamber, introducing gas into the third chamber, and cooling the titanium substrate, and the first-third chambers are chambers different from each other which can be sealed individually. Also, it is preferable that the vacuum heat treatment step includes a temperature raising step of raising the temperature of the titanium substrate and a holding step of holding the titanium substrate whose temperature has been raised in a temperature raised state, and the temperature raising step and the holding step are executed in chambers different from each other.

When the heat treatment step is divided into a plurality of steps and each step can be executed in a different chamber as described above, the heat treatment capacity per unit time can be improved.

In the method for producing a material for fuel cell separators in relation with the present invention, it is preferable that a cutting step of cutting the titanium substrate is further included after the heat treatment step in order to improve the productivity.

Also, by executing a pressing step of forming a gas passage by pressing on the surface of the material for fuel cell separators produced by the method for producing the material for fuel cell separators described above, the fuel cell separators can be produced continuously.

Also, the material for fuel cell separators of a coil shape of the present invention is a material for fuel cell separators of a coil shape including a titanium substrate formed of titanium or titanium alloy with 40 μm or more and 200 μm or less thickness, a carbon layer that coats the titanium substrate, and a middle layer containing titanium carbide between the titanium substrate and the carbon layer, in which the coating area of the carbon layer that coats a substrate after embracing the material for fuel cell separators by two sheets of carbon cloth from both sides, pressing the outside of the carbon cloth with 196 N of the contact load using copper electrodes with 4 cm² of the contact area, and drawing the substrate in the surface direction at a speed of 20 cm/s while maintaining the state pressed from both sides is equal to or greater than a half of the coating area of the carbon layer that coats the substrate before the substrate is drawn.

With the configurations described above, the material for fuel cell separators of a coil shape of the present invention becomes excellent in adhesion and conductive durability between the substrate and the carbon layer, and becomes excellent also in production efficiency.

### Advantageous Effects of Invention

According to the method for producing a material for fuel cell separators in relation with the present invention, a material for fuel cell separators excellent in adhesion and conductive durability between the substrate and the carbon layer, and excellent also in the production efficiency can be produced. Also, according to the material for fuel cell separators in relation with the present invention, a fuel cell separator that can maintain high conductivity even under hot and acidic atmosphere inside the cells of the fuel cell for a long period of time can be provided.

### BRIEF DESCRIPTION OF THE DRAWINGS

FIG. 1A is a schematic view of a contact resistance measuring device for evaluating conductive durability of a material for fuel cell separators of the present invention.

FIG. 1B is a schematic view of an adhesion evaluating device for evaluating adhesion of a material for fuel cell separators of the present invention.

### DESCRIPTION OF EMBODIMENTS

Below, preferred embodiments of a method for producing a fuel cell separator in relation with the present invention will be described in detail.

### <<Fuel Cell Separator>>

First, a fuel cell separator (hereinafter referred to also as “separator” when it is appropriate) produced by the method for producing fuel cell separators in relation with the present invention will be described.

A separator has a structure in which a gas flow passage is formed on the surface of a separator material constructed of a titanium substrate and a carbon layer that coats the surface of the titanium substrate. Also, the carbon layer of the separator material may be formed on one face of the titanium substrate, or may be formed on both faces of the titanium substrate.

Also, the separator is arranged between cells constructed by stacking gas diffusion layers and electrolytic membranes.

Below, the substrate, carbon layer, and middle layer of the material for fuel cell separators which construct a fuel cell separator will be described.

### <<Material for Fuel Cell Separators>>

### <Substrate>

A substrate means the substrate of the material for fuel cell separators in relation with the present invention, and is obtained by forming a sheet material into a shape of a fuel cell separator. As the material of the substrate, pure titanium (titanium) and titanium alloy are used which are particularly suitable to thinning and lightening of a fuel cell separator, and have sufficient acid resistance against acidic atmosphere in the inside of the fuel cell when a fuel cell separator is used for a fuel cell. For example, pure titanium of the kind 1-4 specified in JIS H 4600, Ti-alloy such as Ti—Al, Ti—Ta, Ti-6Al-4V, Ti—Pd can be used, and pure titanium particularly suitable to thinning is preferable among them.

More specifically, as pure titanium or titanium alloy, what is preferable is one with 0 content of 1,500 ppm or less, more preferably 1,000 ppm or less, Fe content of 1,500 ppm or less, more preferably 1,000 ppm or less, C content of 800 ppm or less, N content of 300 ppm or less, H content of 130 ppm or less, with remainder being Ti and unavoidable impurities. However, pure titanium or titanium alloy that can be applied in the present invention is not limited to the above, and those having a composition equivalent to pure titanium or titanium alloy described above containing other metal elements and the like can be used suitably.

Also, sheet material formed of pure titanium or titanium alloy can be produced by a known method as described below. For example, one obtained by annealing a cold rolled sheet of JIS H 4600 kind 1, or one as cold rolled without annealing can be used.

Further, the substrate is required to be capable of being heat treated in a state wound into a coil shape, to be capable of being worked thereafter into a shape of the fuel cell separator, and to satisfy the requirement of lightening and thinning of the fuel cell separator. From the above, the substrate should have the thickness (sheet thickness) of 40 μm-200 μm, and preferably has the length of 100 m or more and the width of 100 mm-20,000 mm.

### <Carbon Layer>

The carbon layer is arranged so as to coat the surface of the substrate of the material for fuel cell separators in relation with the present invention. In other words, the carbon layer is arranged on the surface of the fuel cell separator. Also, the carbon layer imparts conductivity under corrosive environment to the fuel cell separator.

The carbon layer is a layer containing carbon. As carbon used for the carbon layer, although there exist carbon of various crystalline systems and amorphous carbon, graphite is preferable. Also, as the graphite, one containing at least one of flaky graphite powder, scaly graphite powder, expansion graphite powder, and pyrolytic graphite powder is preferable.

Although the attaching amount of the carbon layer on the substrate is not particularly limited, 10-1,000 μg/cm² is preferable. Conductivity and corrosion resistance cannot be secured when the attaching amount of the carbon layer is less, and workability tends to deteriorate when the attaching amount of the carbon layer is much. By making the attaching amount of the carbon layer 10-1,000 μg/cm², conductivity, corrosion resistance, and workability can be secured.

Further, although it is preferable that the carbon layer coats all surface of the substrate, in order to secure conductivity and corrosion resistance, the carbon layer only has to coat the area of at least 40% and preferably 50% or more of the surface of the substrate.

Because the crystalline surface easily slides, graphite is effective in securing followability of the carbon layer at a bending portion with respect to the titanium substrate in a press forming step. Out of graphite, flaky graphite powder, scaly graphite powder, expansion graphite powder, and pyrolytic graphite powder are preferable because sliding of the crystalline surface is effected very easily due to not only that the form of powder is flaky but also the powder particle itself has a construction that thin graphite flakes with further thinner thickness are stacked.

The grain size of graphite is preferable to be 0.02-100 μm. When the grain size of graphite is less than 0.02 μm, the stress applied to graphite in crimp rolling becomes small, and therefore adhesion of the graphite and the substrate is hardly improved. When the grain size of the graphite exceeds 100 μm, the thickness of the carbon layer obtained after rolling is excessively thick, and peeling off of the carbon layer is liable to occur in the press forming step.

In the carbon layer, in addition to carbon added beforehand such as the graphite described above, amorphous carbon can be further contained which is generated by that the binder compound component described below is carbonized by heat treatment.

### <Middle Layer>

The middle layer is a layer formed between the substrate and the carbon layer by the method for producing the material for fuel cell separators in relation with the present invention, and is a layer containing titanium carbide. The middle layer is a layer containing titanium carbide (TiC) that is formed by that C and Ti diffuse and react with each other at the interface of the carbon layer and the substrate, or a layer containing titanium carbide and carbon dissolved titanium (C-dissolved Ti). This middle layer is of a complex structure formed by that granular titanium carbide or titanium carbide and carbon dissolved titanium overlap with each other, and are lined along the surface direction between the substrate and the carbon layer. The carbon layer and the substrate are chemically adhered to each other securely through this middle layer. As described below, this middle layer is formed by forming a coating layer containing carbon on the titanium substrate, and executing heat treatment thereafter.

### <<Method for Producing Material for Fuel Cell Separators>>

Next, the method for producing a material for fuel cell separators in relation with the present invention will be described sequentially for each production step.

### <Substrate Production Step>

The substrate production step is a step of producing a sheet (strip) material by casting and hot rolling pure titanium or titanium alloy described above by a known method, executing annealing and acid washing treatment and the like according to the necessity in between, rolling to a desired thickness by cold rolling, and annealing. Here, annealing is a treatment of controlling formability after rolling by controlling the grain size by heating treatment.

When the cold rolled material described above without executing annealing treatment after cold rolling is used as the substrate, the heat treatment for forming the middle layer described below can double the process equivalent to this annealing. Such method can simplify the process, and is preferable from the viewpoint of productivity and cost.

Also, presence/absence of acid washing after cold rolling (+after annealing) is no object.

### <Coating Step>

The coating step is a step of producing the substrate having a coating layer by coating slurry including a binder compound containing carbon atoms and oxygen atoms and carbon on the surface of the substrate.

Here, the binder compound containing carbon atoms and oxygen atoms is a substance having a film forming property used in forming the coating layer containing carbon on the surface of the substrate. Carboxymethyl cellulose, polyester resin, phenolic resin, epoxy resin and the like are representative.

Also, carbon is used for forming a carbon layer on the surface of the titanium substrate, constructs the carbon layer, and is preferable to be one excellent in conductivity. Further, as described above, carbon can react with titanium at the interface of the carbon layer and the substrate, and can form titanium carbide and carbon dissolved titanium. More specifically, as described above, it is carbon of various crystalline systems and amorphous carbon, and graphite is a representative one.

As concrete examples of the coating method, there are a method of preparing solution in which graphite is mixed in solvent, or slurry in which graphite is dispersed in a binder compound, solvent, or a binder compound and solvent, the solution or slurry is coated on the surface of the substrate and is dried, and a method of kneading graphite powder into a resin (phenolic resin and the like), preparing a film, and sticking the film on the surface of the substrate. In other words, the method is not limited to a method of so-called coating.

The use amount of the binder compound coated is preferable to be as little as possible because carbon dioxide gas and carbon mono-oxide gas are generated in the heat treatment step of a post process. However, the exhaust amount of the generated gas per unit time can be controlled by the feeding amount to a vacuum heat treatment furnace, the displacement of a vacuum pump, and the treatment temperature thermal pattern, and there is no restriction of the use amount of the binder compound intrinsically in particular.

Further, although a method for coating the coating liquid is not particularly limited, coating of the substrate can be executed using a bar coater, roll coater, gravure coater, micro-gravure coater, dip coater, spray coater, and the like.

### <Crimping Step>

The crimping step is a step of crimping the substrate coated with the coating layer after the coating step and before the heat treatment step described below. Here, crimping means pressing or roll pressing in a range the variation rate of the thickness of the substrate becomes 5% or less. The substrate thickness variation rate by crimping of the substrate can be obtained by the following expression.

Substrate thickness variation rate (%)=100×(t0−t1)/t0

Here, t0: substrate thickness (μm) before crimping, t1: substrate thickness (μm) after crimping, and the thickness of the coating layer is not included in the substrate thickness.

By crimping the coating layer to the substrate after the coating step and before the heat treatment step, adhesion of the carbon layer formed in the heat treatment step with respect to the substrate can be further improved. When adhesion of the substrate and the carbon layer can be improved, the electric resistance (contact resistance) at the interface of the substrate and the carbon layer reduces, and a material for fuel cell separators excellent in conductivity can be produced. Also, because the carbon layer can be adhered to the surface of the substrate for a long period of time, a material for fuel cell separators excellent in conductive durability can be produced.

### <Heat Treatment Step>

The heat treatment step is a step of heat treatment of the titanium substrate wound into a coil shape and coated with the coating layer. Therefore, the titanium substrate having gone through the substrate production step, coating step, and crimping step described above and coated with the coating layer is required to be wound into a coil shape before executing this heat treatment step. With respect to the core that is a core material for winding the substrate into a coil shape, a metal-made core (stainless core, iron core, and the like) that can stand the highest temperature can be used, however, from the viewpoint of thermal expansibility, the core made of titanium is most preferable.

In the heat treatment step, the carbon layer is formed by heat treatment of the binder compound and the carbon in the coating layer. Also, a naturally oxidized film present on the surface of the substrate is eliminated, and a middle layer that is a layer containing titanium carbide or a layer containing titanium carbide and carbon dissolved titanium is formed between the substrate and the carbon layer. As a result, adhesion of the substrate and the carbon layer can be improved by the middle layer formed.

The heat treatment temperature in the heat treatment step is preferable to be 350-780° C. Because the substrate made of pure titanium or titanium alloy is used as a substrate, by heat treatment at a temperature of 350° C. or above, the middle layer is formed at the interface of the carbon layer and the substrate, and electric conductivity improves in addition to improvement of adhesion at the interface. When the heat treatment temperature is below 350° C., reaction between the carbon layer (graphite) and the substrate is hardly effected, and adhesion hardly improves. On the other hand, when the heat treatment temperature exceeds 780° C., the mechanical properties of the substrate possibly deteriorate. The range of the heat treatment temperature is preferably 400-750° C., and more preferably 450-700° C.

This heat treatment step should be executed under vacuum atmosphere of 10 Pa or below. When the degree of vacuum exceeds 10 Pa, gas such as carbon dioxide gas or carbon mono-oxide gas is generated accompanying heat treatment of the binder compound, and the degree of vacuum further deteriorates. Because of this, generated gas stays within the coating layer for a long period of time, the coating layer and the substrate are thereby oxidized, and therefore adhesion deteriorates.

To be more specific, when heat treatment is executed under the atmospheric pressure in a state the titanium substrates are wound into a coil shape and the titanium substrates are stacked, gas generated from the binder compound by heat treatment comes to surround the vicinity of the coating layer. Therefore, the coating layer is oxidized by the generated gas, and the carbon layer formed becomes brittle. Further, because the surface of the substrate is also oxidized and the middle layer does not grow sufficiently, adhesion between the carbon layer and the substrate is deteriorated, and conductive durability also deteriorates.

Also, by executing heat treatment in a state the titanium substrates are wound into a coil shape, heat treatment of the substrate can be executed with high production efficiency. Further, in the heat treatment under the vacuum atmosphere, other than an inert gas used in cooling, a process gas is not required to be used, and therefore the material for fuel cell separators can be produced at a low cost.

The holding time at the highest temperature of the heat treatment is important particularly in formation of the middle layer, and 10 min-10 hours is preferable. Even within the range of the heat treatment temperature of 350-780° C. described above, the treatment time can be adjusted appropriately according to the heat treatment temperature. For example, treatment of long time is required when the heat treatment temperature is comparatively low, and heat treatment of short time is enough when the heat treatment temperature is comparatively high.

In such temperature region where much amount of gas is generated from the binder compound and the like in temperature raising of heat treatment, in order to suppress the generation rate of the gas and to maintain the degree of vacuum in the range of 10 Pa or below, temperature raising rate is slowed down, or the temperature is maintained constant. In other words, the temperature pattern of temperature raising can be appropriately adjusted in order to maintain the degree of vacuum in a predetermined range. Because this temperature at which gas is generated changes according to the kind of the binder compound, it is preferable to check the temperature range of gas generation by heat treatment of the binder compound beforehand, and to set the temperature pattern of temperature raising considering the checking result.

For example, when methyl cellulose is used as the binder compound, it is preferable to slow down the temperature raising rate or to maintain the temperature constant in the range of 200-450° C. which is the temperature range methyl cellulose is heat-decomposed and gas is generated.

With respect to cooling after heat treatment, although it is possible to lower the temperature by natural cooling of the vacuum heat treatment furnace, from the viewpoint of improving productivity by shortening the process time, it is preferable to lower the temperature inside the furnace in a short time by introducing argon gas or nitrogen gas into the furnace.

As far as heat treatment can be executed at the heat treatment temperature of 350-780° C. and under the vacuum atmosphere, any known heat treatment furnace such as a vacuum heat treatment furnace and electric furnace can be used for heat treatment.

Also, from the viewpoint of improving productivity, it is preferable to use a vacuum heat treatment furnace of the multi-chamber type. For example, it is preferable to execute each step of a decompression step of decompression from the atmospheric pressure to obtain the initial degree of vacuum, a temperature raising step, a vacuum heat treatment step of keeping at the highest arrival temperature, and a cooling step respectively in heat treatment chambers different from each other.

More specifically, in each step of the decompression step of carrying in the titanium substrates in a coil shape into a first chamber and thereafter decompressing the first chamber, the vacuum heat treatment step of moving the titanium substrates from the decompressed first chamber to a second chamber maintained at vacuum atmosphere, heating the titanium substrates and executing heat treatment in the second chamber, and the cooling step of moving the titanium substrates having been subjected to heat treatment to the third chamber and introducing gas into the third chamber to cool the titanium substrates, the first-third chambers can be made chambers sealable respectively and different from each other.

Among these steps, in the vacuum heat treatment step that is particularly important for forming the middle layer, the degree of vacuum should be kept at 10 Pa or below. On the other hand, in the decompression step and the cooling step, the decompression state and the non-decompression state are repeated. Therefore, by separating each step by the chamber, respective batches can be processed in respective chambers simultaneously, namely three batches can be processed simultaneously, and therefore productivity can be improved.

Also, the vacuum heat treatment step includes a temperature raising step of raising the temperature of the titanium substrates, and a holding step of holding the titanium substrates whose temperature has been raised in a temperature raised state. Apart from the holding step of holding the titanium substrates whose temperature has been raised for a specific time in the temperature raised state, in the temperature raising step of raising the temperature of the substrates, a non-heating state and a heating state are repeated. Therefore, by executing these steps in different chambers, the heat treatment capacity per unit time can be improved.

For example, when the temperature raising step takes 3 hours, the holding step takes 3 hours, and the cooling step takes 2 hours, if these steps are to be processed in one chamber, the processing time becomes 8 hours in total per one coil. On the other hand, when the temperature raising step, the holding step, and the cooling step are processed in separate chambers and a plurality of coils are processed in parallel, the processing time can be made less than 5 hours in total per one coil.

### <Straightening Step>

The straightening step (leveling step) is a step of straightening the warp of the substrate in the longitudinal direction generated in the heat treatment to flatten the substrate. Normally, flatness of the substrate is required in the forming step of the post process. Although it depends on the specification of the flatness of the material for the fuel cell separators, when high flatness is required, it is preferable to add the straightening step that executes flattening.

The substrate can be straightened by using devices such as a leveler device that flattens the substrate by making the substrate pass through a gap where sequential rollers with the diameter of 20 mm or less are disposed in the top and bottom, a tension leveler device that makes the substrate to pass through the leveler while applying tension, a tension anneal device that executes heat treatment while applying tension to the substrate.

Because the titanium substrate naturally curls in general by heat treatment, flatness of the substrate is possibly deteriorated. Therefore, when flatness of the substrate is deteriorated, it is necessary to execute flattening work for the substrate in the straightening step after the heat treatment step. However, because there is a limit in straightening, it is preferable that the coil inside diameter of the titanium substrate (core outside diameter) in executing straightening is 75 mm or more. The coil of the titanium substrate is formed by using a cylindrical core and winding the substrate around the core. Therefore, the inside diameter of the coil becomes the same dimension as that of the outside diameter of the core.

On the other hand, when the coil inside diameter is large, the straightening step is not necessarily required. When the coil inside diameter is 400 mm or more, the warp of the substrate is small and the straightening step is not necessary normally which is therefore preferable. The coil inside diameter is more preferably 600 mm or more, and further more preferably 1,000 mm or more. However, because productivity is deteriorated when the coil inside diameter is excessively large, it is preferable that the coil inside diameter is 4 m or less.

### <Cutting Step>

In the method for producing the material for fuel cell separators in relation with the present invention, it is preferable to further include a cutting step of cutting the titanium substrate having been subjected to heat treatment after the heat treatment step in order to improve productivity.

### <Order of Producing Step>

Although the method for producing the material for fuel cell separators in relation with the present invention is executed in the order of the substrate producing step, coating step, crimping step, heat treatment step, straightening step, and cutting step, the crimping step and straightening step may be appropriately selected and executed according to the necessity.

### <<Method for Producing Fuel Cell Separator>>

By subjecting the surface of the material for fuel cell separators produced using the producing method described above to a pressing step of forming a gas flow passage by pressing, the fuel cell separator can be produced continuously.

### <<Material for Fuel Cell Separators of Coil Shape>>

The material for fuel cell separators of a coil shape in relation with the present invention is a material for fuel cell separators of a coil shape including a titanium substrate formed of titanium or titanium alloy with 40 μm or more and 200 μm or less thickness, a carbon layer that coats the titanium substrate, and a middle layer between the titanium substrate and the carbon layer, in which the coating area of the carbon layer that coats a substrate after embracing the material for fuel cell separators by two sheets of carbon cloth from both sides, pressing the outside of the carbon cloth with 196 N of the contact load using copper electrodes with 4 cm² of the contact area, and drawing the substrate in the surface direction at a speed of 20 cm/s while maintaining the state pressed from both sides is equal to or greater than a half of the coating area of the carbon layer that coats the substrate before the substrate is drawn.

The material for fuel cell separators of a coil shape of the present invention is produced by the producing method described above. Also, with the configuration described above, the material for fuel cell separators of a coil shape of the present invention becomes excellent in adhesion between the substrate and the carbon layer, can maintain high conductivity even under hot and acidic atmosphere inside the cells of the fuel cell for a long period of time, and becomes excellent also in production efficiency.

### EXAMPLES

### Examples 1-5

### Comparative Examples 1-3

Next, with respect to the method for producing the material for fuel cell separators of the present invention, specimens satisfying the requirement of the present invention (examples 1-5) and specimens not satisfying the requirement of the present invention (comparative examples 1-3) will be compared each other, and will be described specifically.

### [Substrate]

As the substrate, the titanium substrate (cold rolled sheet) of JIS H 4600 kind 1 with 0.1 mm thickness was used. The chemical composition of the titanium substrate was 450 ppm of 0 content, 250 ppm of Fe content, 40 ppm of N content, with the remainder consisting of Ti and unavoidable impurities, and the size was 240 mm width×500 mm length. Also, the titanium substrate was obtained by subjecting titanium raw material to known melting step, casting step, hot rolling step (with acid washing), and cold rolling step (without acid washing).

### [Coating Step]

Slurry was prepared by dispersing expansion graphite powder (SNE-6G made by SEC CARBON, Ltd., 7 μm average grain size, 99.9% purity) in 1 wt % methyl-cellulose aqueous solution so as to be 10 wt % content. Also, the slurry was coated on the surface of the substrate using a micro-gravure device. Thus, the coated layers were formed on both surfaces of the substrate. The attaching amount of one surface was approximately 300 μg/cm² after drying.

### [Crimping Step]

The substrate having the coating layers described above was crimped applying 6 tons load using a roll press with 200 mm diameter.

### [Heat Treatment Step]

The titanium substrates having been subjected to the crimping process described above were wound into a coil shape having predetermined coil inside diameter shown in Table 1 and were subjected to heat treatment for each example and comparative example. For the examples 1-5 and the comparative example 3, heat treatment was executed with the following procedure using a vacuum heat treatment furnace. After the degree of vacuum inside the furnace reached 2×10⁻³ Pa, the temperature was raised at 200° C./hour from the room temperature, the temperature was raised at 50° C./hour in the temperature range of 200° C.-450° C. which was the temperature range methyl cellulose that was the binder compound component was heat-decomposed, and the temperature was raised again at 200° C./hour from 450° C. to the highest arrival temperature. The highest arrival temperature and the holding time at the highest arrival temperature are described as the process temperature and process time respectively in Table 1. Also, the maximum value of the pressure inside the furnace at the time of heat treatment is described in Table 1. Thereafter, cooling was executed under high purity argon gas atmosphere of 99.9999%. The cooling time then to 50° C. was 1 hour.

The heat treatment for the comparative example 1 under the nitrogen gas atmosphere was executed with the heat treatment condition similar to that of the example 4 with the exception of execution under the atmospheric pressure (1×10⁵ Pa) using high purity nitrogen gas of 99.999% purity.

The heat treatment for the comparative example 2 under the argon gas atmosphere was executed with the heat treatment condition similar to that of the example 4 with the exception of execution under the atmospheric pressure (1×10⁵ Pa) using high purity argon gas of 99.9999% purity. However, cooling was executed under the nitrogen gas atmosphere instead of under the argon gas atmosphere.

### [Straightening Step]

In the example 1, flattening was executed using a leveler in which rollers with 16 mm roller diameter were disposed by 11 pieces in the top and 12 pieces in the bottom applying the tension of 180 kgf (tension leveler).

In the example 2, flattening was executed using a leveler in which rollers with 8 mm roller diameter were disposed by 13 pieces in the top and 14 pieces in the bottom (tension was not applied) (leveler).

In the example 3, heat treatment was executed for 1 min at 700° C. in a state the tension of 20 kgf was applied (tension thermal anneal).

### [Evaluation of Conductive Durability]

With respect to the specimens manufactured by the method described above, evaluation of durability (durability test) of conductivity was executed.

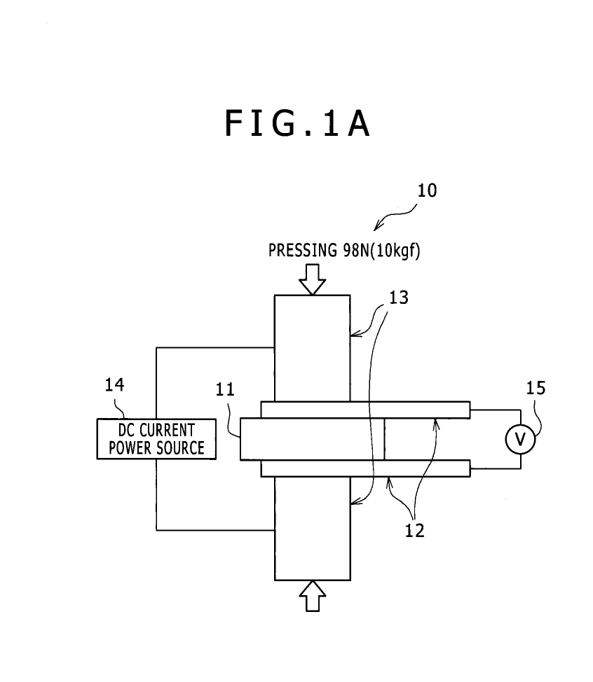

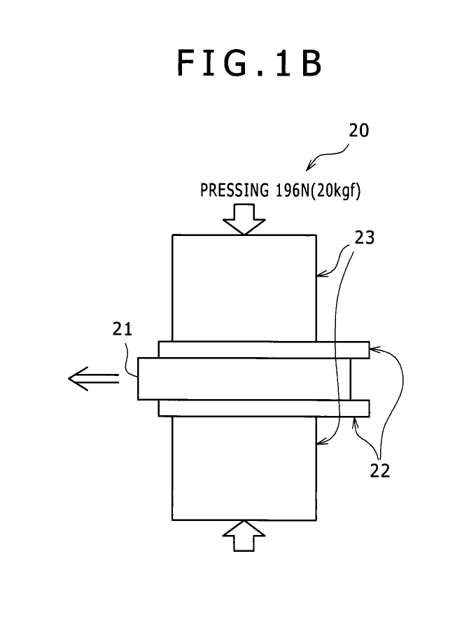

FIG. 1A is a schematic view of a contact resistance measuring device 10 for evaluating the contact resistance of the material for fuel cell separators of the present invention.

After the specimen was immersed in a sulfuric acid aqueous solution (10 mmol/L) of 80° C. whose specific solution volume was 20 ml/cm² for 1,000 hours, the specimen was taken out from the sulfuric acid aqueous solution, washed and dried, and the contact resistance was measured.

The contact resistance was obtained by embracing both surfaces of the specimen 11 by two sheets of carbon cloth 12, further embracing the outside thereof by two sheets of copper electrode 13 with the contact area of 1 cm², being pressed by the load of 98 N (10 kgf), energizing with the current of 7.4 mA using a DC current power source 14, and measuring the voltage applied between the two sheets of carbon cloth 12 using a voltmeter 15. Two positions of the outside and the center part of the specimen were measured.

The case the contact resistance after immersion in the sulfuric acid (after the durability test) (shown as conductive durability in Table 2) was 15 mΩ·cm² or less was determined to have excellent conductive durability, and the case exceeding 15 mΩ·cm² was determined to be inferior in conductive durability.

### [Evaluation of Adhesion]

FIG. 1B is a schematic view of an adhesion evaluating device 20 for evaluating adhesion of the material for fuel cell separators of the present invention.

The specimen 21 manufactured by the method described above was embraced by two sheets of carbon cloth 22 from both surfaces, and the outside thereof was further embraced by copper electrodes 23 with the contact area of 4 cm² and was pressed by the contact load of 196 N (20 kgf). The specimen 21 was drawn in the surface direction at the rate of 20 cm/s while keeping the state of being pressed from both surfaces (drawing test). After the drawing test, the sliding region of the surface of the specimen 21 by the copper electrodes 23 was observed by visual inspection, and was evaluated according to the remaining state of the carbon layer which was the degree of exposure of the substrate.

With respect to the determination criterion of adhesion, the case the coating rate (B) with respect to the titanium substrate of the carbon layer obtained by image processing of the optical microscopic photo (400 magnifications) of the surface of the substrate after the drawing test relative to the coating rate (A) obtained by similar measurement before the drawing test was not changed at all (B/A ratio=1) was determined to be superior “⊚, one in which B/A ratio was secured by 0.5 or more was determined to be excellent “◯”, and the case in which B/A ratio was the coating rate of less than 0.5 was determined to be inferior “X”.

### [Evaluation of Flatness]

With respect to flatness, flatness in the longitudinal direction was evaluated. The substrate cut to 50 cm length was placed on a stone block whose flatness was 50 μm or less, the height of both ends was measured, then the substrate was overturned, similar measurement was executed, and the average value of the height of both ends of the surface whose measured value was larger was made the value (cm) of the flatness. With respect to flatness, one with less than 1 cm was determined to be superior “⊚”, one with 1 cm or more and less than 5 cm was determined to be excellent “◯”, one with 5 cm or more was determined to have failed “X”, and one with less than 5 cm was determined to have passed.

The evaluation results of conductive durability, adhesion, and flatness of each specimen of the examples 1-5 and the comparative examples 1-3 were shown in Table 2.

TABLE 1

| | | | Heat treatment condition | | | |
|---|---|---|---|---|---|---|
| | Process method | | | Maximum value | | |
| | Heat | | Coil inside | of pressure | Process | Process |
| | treatment | | diameter | inside furnace | temperature | time |
| | atmosphere | Straightening step | mm | Pa | ° C. | Hour |
| Example 1 | Vacuum | Tension leveler | 150 | 4 × 10⁻² | 550 | 5 |
| Example 2 | Vacuum | Leveler | 350 | 2 × 10⁻² | 550 | 5 |
| Example 3 | Vacuum | Tension thermal anneal | 350 | 1 × 10⁻² | 550 | 5 |
| Example 4 | Vacuum | — | 450 | 8 × 10⁻¹ | 550 | 5 |
| Example 5 | Vacuum | — | 1000 | 5 × 10⁻² | 550 | 5 |
| Comparative | Nitrogen | — | 450 | 1 × 10⁵ | 550 | 5 |
| example 1 | | | | | | |
| Comparative | Argon | — | 450 | 1 × 10⁵ | 550 | 5 |
| example 2 | | | | | | |
| Comparative | Vacuum | — | 75 | 1 × 10² | 550 | 5 |
| example 3 | | | | | | |

TABLE 2

| | Conductive durability | | | | | |
|---|---|---|---|---|---|---|
| | | Center | Adhesion | | Flatness | |
| | Outside | part | | Center | | Center |
| | mΩ · cm² | mΩ · cm² | Outside | part | Outside | part |
| Example 1 | 5.2 | 5.4 | ⊚ | ⊚ | ⊚ | ⊚ |
| Example 2 | 5 | 4.8 | ⊚ | ⊚ | ⊚ | ⊚ |
| Example 3 | 4.9 | 5.1 | ⊚ | ⊚ | ⊚ | ⊚ |
| Example 4 | 8.1 | 7.1 | ⊚ | ⊚ | ◯ | ◯ |
| Example 5 | 5.3 | 5.2 | ⊚ | ⊚ | ⊚ | ⊚ |
| Compar- | 18.8 | 20.3 | X | X | ◯ | ◯ |
| ative | | | | | | |
| example 1 | | | | | | |
| Compar- | 17.5 | 17.3 | X | X | ◯ | ◯ |
| ative | | | | | | |
| example 2 | | | | | | |
| Compar- | 14.3 | 18.5 | ◯ | X | X | X |
| ative | | | | | | |
| example 3 | | | | | | |

In the examples 1-5, all conditions of the production condition of the present invention were satisfied, and the specimens obtained were excellent in characteristic evaluation of all of conductive durability, adhesion, and flatness and had excellent characteristics. Also, in the examples 1-5, it was confirmed that the middle layer containing titanium carbide was formed.

The comparative examples 1 and 2 were inferior in conductive durability and adhesion because heat treatment was executed under the atmospheric pressure of the nitrogen gas or argon gas atmosphere.

Also, in the comparative example 3, the maximum value of the pressure inside the furnace at the time of heat treatment was higher than the specified value, conductive durability and adhesion were inferior, and flatness could not be secured because the coil inside diameter was as small as 75 mm.

### REFERENCE SIGNS LIST

10 . . . contact resistance measuring device,
11, 21 . . . specimen,
12, 22 . . . carbon cloth,
13, 23 . . . copper electrode,
14 . . . DC current power source,
15 . . . voltmeter,
20 . . . adhesion evaluating device

1. A method for producing a material for fuel cell separators, the method comprising:
forming a coating layer, which comprises carbon and a binder compound comprising a carbon atom and an oxygen atom, on a surface of a titanium substrate of titanium or titanium alloy with a thickness of 40 μm or more and 200 μm or less to obtain a titanium substrate coated by the coating layer; and
subjecting the titanium substrate coated by the coating layer to a heat treatment,
wherein
the titanium substrate coated by the coating layer is subjected to the heat treatment in a state wound into a coil shape,
the heat treatment is executed under a vacuum atmosphere of 10 Pa or below, and
a carbon layer is formed from the coating layer and a middle layer comprising titanium carbide is formed between the titanium substrate and the carbon layer in the heat treatment.

2. The method according to claim 1, wherein
the titanium substrate subjected to the heat treatment is a cold rolled material, and is not subjected to annealing treatment after cold rolling.

3. The method according to claim 1, further comprising:
crimping the titanium substrate coated by the coating layer is after said forming and before said subjecting.

4. The method according to claim 1, further comprising:
straightening a warp of the titanium substrate after said subjecting.

5. The method according to claim 1, wherein
the coil shape has a coil inside diameter of 400 mm or more.

6. The method according to claim 1, wherein
said subjecting comprises:
(i) carrying the titanium substrate coated by the coating layer into a first chamber, and decompressing the first chamber;
(ii) moving the titanium substrate from the first chamber decompressed to a second chamber maintained at a vacuum atmosphere, and heating the titanium substrate and subjecting the titanium substrate to the heat treatment in the second chamber; and
(iii) moving the titanium substrate subjected to the heat treatment to a third chamber with gas introduced into the third chamber, and cooling the titanium substrate,
wherein the first, second, and third chambers are chambers different from each other which optionally are sealed individually.

7. The method according to claim 6, wherein
said moving (ii) comprises: raising a temperature of the titanium substrate and subsequently holding the titanium substrate in a temperature raised state, and
said raising and said holding are executed in chambers different from each other.

8. The method according to claim 1, further comprising:
cutting the titanium substrate after said subjecting.

9. A method for producing a fuel cell separator, the method comprising:
producing a material for fuel cell separators by the method according to claim 1; and
forming a gas passage by pressing on a surface of the material for fuel cell separators.

10. A material for fuel cell separators of a coil shape, the material comprising:
a titanium substrate of titanium or titanium alloy with a thickness of 40 μm or more and 200 μm or less,
a carbon layer that coats the titanium substrate, and
a middle layer comprising titanium carbide between the titanium substrate and the carbon layer,
wherein
a coating area of the carbon layer after embracing the material for fuel cell separators by two sheets of carbon cloth from both sides, pressing an outside of the carbon cloth with 196 N of a contact load using copper electrodes with 4 cm² of the contact area, and drawing the substrate in a surface direction at a speed of 20 cm/s while maintaining a state pressed from both sides is equal to or greater than a half of a coating area of the carbon layer that coats the substrate before the substrate is drawn.
